(19) United States
(12) Patent Application Publication
(10) Pub. No.: US 2012/0051551 A1
(43) Pub. Date: Mar. 1, 2012

(54) ELECTRONIC DEVICE AND METHOD FOR CONTROLLING AUDIO OUTPUT

(75) Inventors: HAO-CHUN CHEN, Tu-Cheng (TW); I-CHUN YANG, Tu-Cheng (TW); YAO-TING WU, Tu-Cheng (TW); YAO-TUNG KUO, Tu-Cheng (TW)

(73) Assignee: HON HAI PRECISION INDUSTRY CO., LTD., Tu-Cheng (TW)

(21) Appl. No.: 13/155,418

(22) Filed: Jun. 8, 2011

(30) Foreign Application Priority Data
Aug. 26, 2010 (CN) 201010263709.2

(51) Int. Cl. H04R 29/00

(52) U.S. Cl. 381/58

(57) ABSTRACT

An electronic device includes a storing module, an accelerometer, a first audio output module, and a control module. The storing module is configured to store a reference angle. The accelerometer is configured to sense acceleration of the electronic device along three axes X, Y, Z, wherein the X, Y, Z axes are all perpendicular to each other. The first audio output module is configured to output audio signals. The control module is configured to obtain an angle of rotation of the electronic device according to the values, and turn the first audio output module on after determining the angle is greater than the reference angle.

### BACKGROUND

1. Technical Field

The present disclosure relates to electronic devices and methods, and particularly to, an electronic device and method for controlling audio output of the device.

2. Description of Related Art

There are many different kinds of electronic devices used for outputting audio signals. Each kind of electronic device may have many audio output modules, such as auxilliary speakers. A user may activate all the audio output modules when playing a movie on the electronic device. If, however, the user wants to read an e-book on the electronic device, he may deactivate some or all of the audio output modules for saving power. However, users must adjust the audio output modules manually, which is inconvenient for users.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an embodiment.

FIG. 2 is a schematic view of the electronic device in a first status.

FIG. 3 is a schematic view of the electronic device in a second status.

FIG. 4 is a flow chart of method for controlling audio output in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

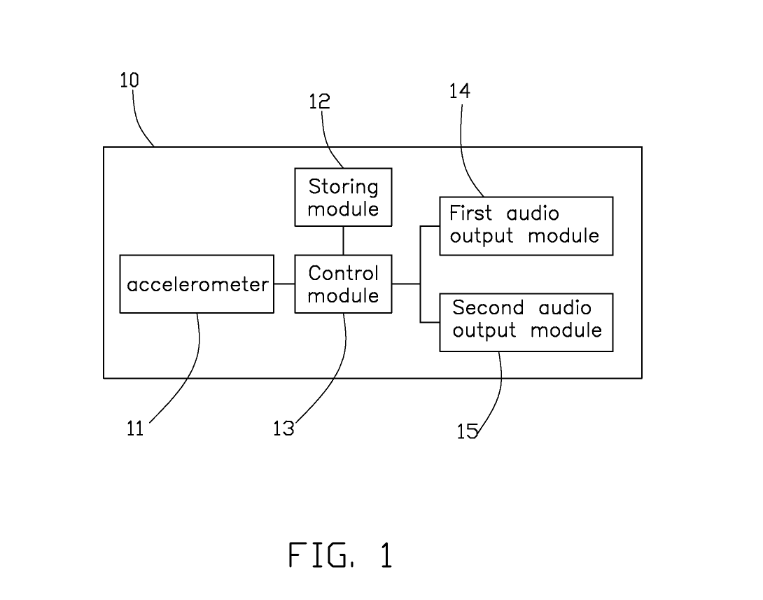

Referring to FIGS. 1 to 3, an electronic device 10 includes an accelerometer 11, a storing module 12, a control module 13, a first audio output module 14, and a second output module 15. In one embodiment, the electronic device 10 is a mobile terminal.

The accelerometer 11 and the storing module 12 are both connected to the control module 13. The control module 13 is connected to the first audio output module 14 and the second audio output module 15.

The accelerometer 11 is used for sensing acceleration along three axes, X, Y, Z, of the electronic device 10. The X, Y, Z axes are all perpendicular to each other. The accelerometer 11 is used for sending the values of sensed acceleration to the control module 13. The X, Y axes are in a plane of the electronic device 10. The z-axis is perpendicular to the plane of the electronic device 10. The storing module 12 is used for storing a reference angle.

The control module 13 is used for obtaining a tangent value of a rotating angle of the electronic device 10 according to the two sensed X, Y values. The rotation of the electronic device 10 js detected in the plane and is denoted as Xg and Yg along the X, Y axes. The control module 13 is used for obtaining an angle of rotation according to the tangential value tan(Xg/Yg), and controlling the first audio output module 14 and the second audio output module 15 after comparing the angle with the reference angle.

In one embodiment, the first audio output module 14 and the second audio output module 15 are loudspeakers.

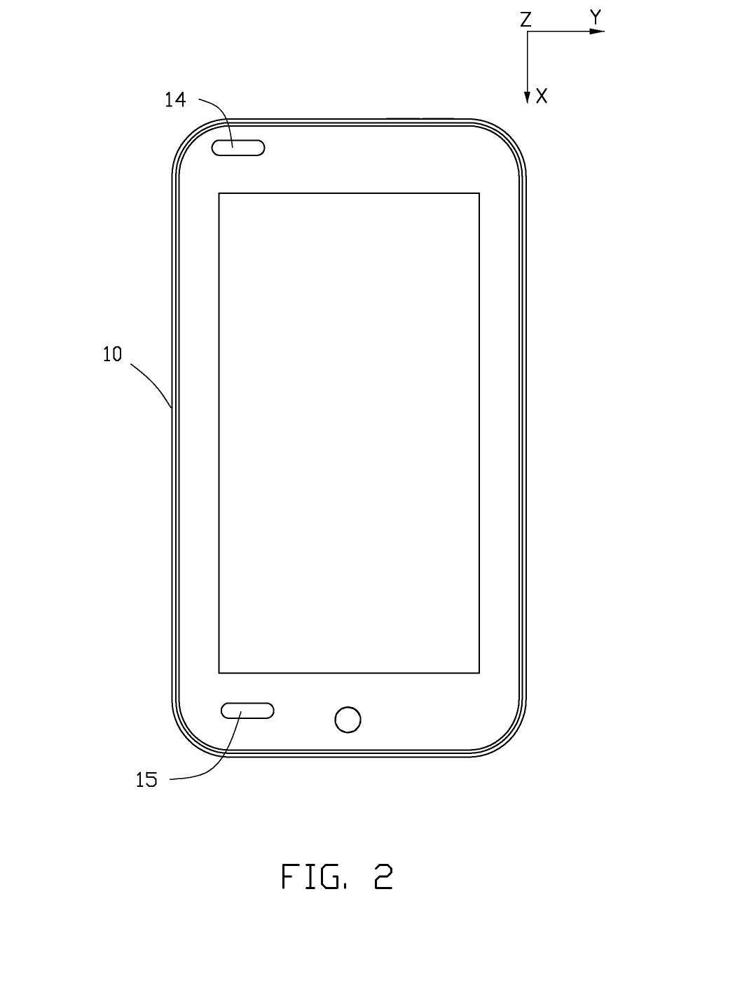

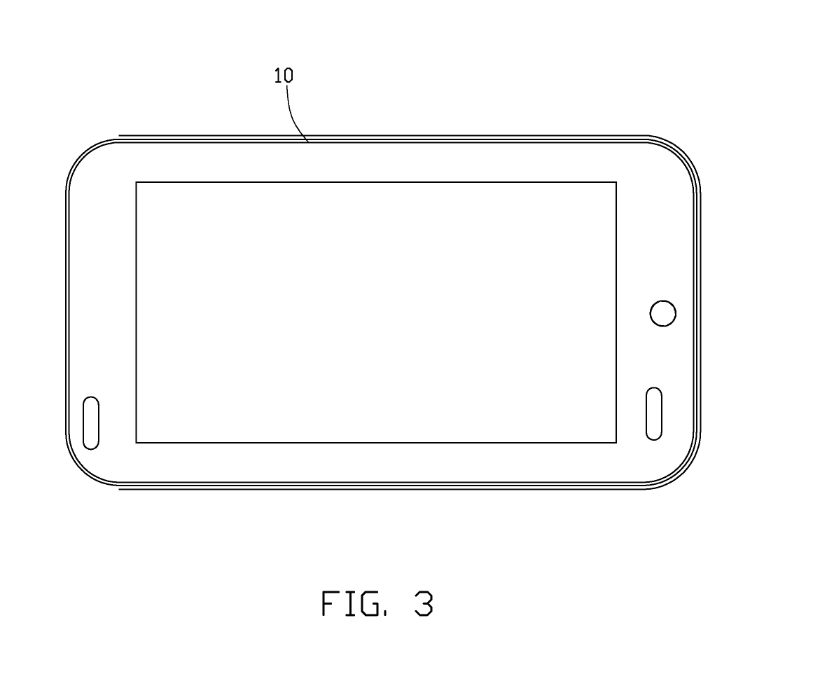

Referring to FIGS. 1 and 2, the electronic device 10 is disposed in a first status. The first audio output module 14 and the second audio output module 14 are disposed on opposite sides of the electronic device 10. At this time, users may send short messages or make phone calls. An operating system of the electronic device 10 is in a first mode. One of the first audio output module 14 and the second audio output module 15 is on. Audio signals can be output from the one audio output module. Referring to FIGS. 1 and 3, the electronic device 10 is disposed in a second status. At this time, the first audio output module 14 and the second audio output module 15 are both on. Users may watch a movie in the second status. The operating system is in a second mode. Audio signals can be output from the two audio output modules in stereo.

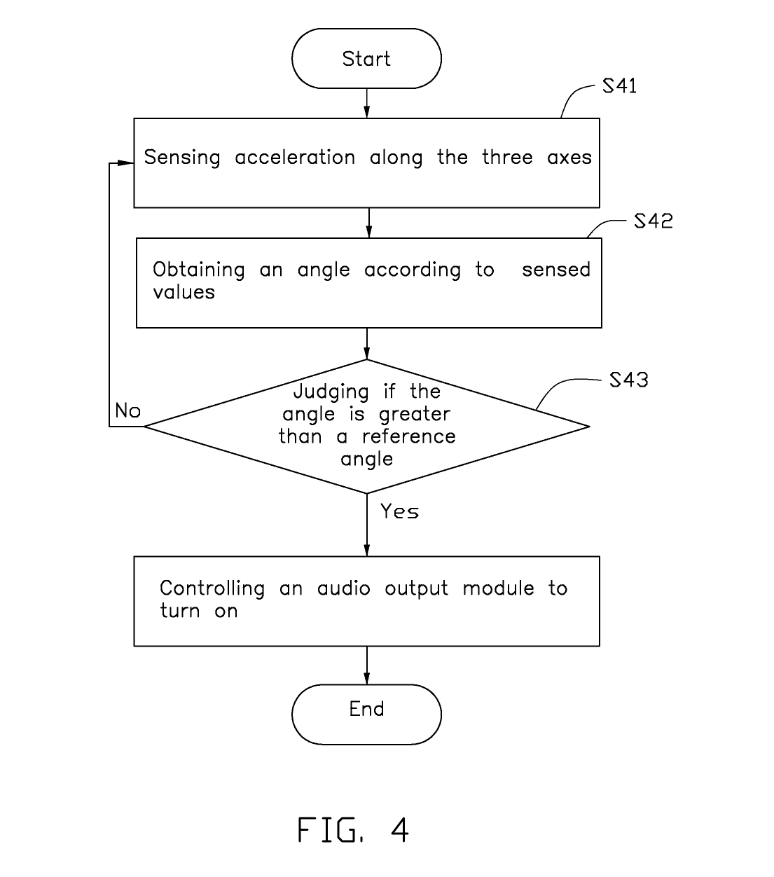

Referring to FIG. 4, an audio output method is shown. An embodiment of the method is as follows.

In step S41, the accelerometer 11 senses acceleration of the electronic device 10 along the X, Y, Z axes and sends the three sensed values to the control module 13 when the electronic device 10 is rotated from the first status to the second status.

In step S42, the control module 13 obtains an angle of rotation of the device 10 according to the sensed values along the X, Y axes.

In step S43, the control module 13 judges if the angle is greater than the reference angle stored in the storing module 12. If so, the control module 13 controls the second audio output module 15 to also turn on. If not, flow returns to step S41.

Likewise, when the device 10 is sensed having been rotated from the second status to the first status, the control module 13 turns the second audio output module 15 off.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device, comprising:
a storing module, the storing module configured to store a reference angle;
an accelerometer, the accelerometer configured to sense acceleration of the electronic device along three axes X, Y, Z, wherein the X, Y, Z axes are all perpendicular to each other;
a first audio output module, the first audio output module configured to output audio signals; and
a control module, the control module configured to obtain an angle of rotation of the electronic device according to sensing values from the accelerometer along the X, Y axes, and turn the first audio output module on after determining the angle is greater than the reference angle.

2. The electronic device of claim 1, further comprising a second audio output module being turned on, wherein the first audio output module and the second audio output module are disposed on opposite sides of the electronic device.

3. The electronic device of claim 1, wherein the control module is further configured to switch an operating system of the electronic device from a first model to a second model after determining the rotating angle is greater than the reference angle.

4. The electronic device of claim 1, wherein the X, Y axes is defined in a plane of the electronic device, and the control module is configured to obtain a tangent value according to two sensing values corresponding to the X, Y axes, and further obtain the angle according to the tangential value.

5. An electronic device, comprising:
a storing module, the storing module configured to store a reference angle;
an accelerometer, the accelerometer configured to sense acceleration of the electronic device along three axes X, Y, Z, wherein the X, Y, Z axes are all perpendicular to each other;
a first audio output module, the first audio output module being turned on;
a second audio output module, the second audio output module being turned on; and
a control module, the control module configured to obtain an angle of rotation of the electronic device according to sensed values from the accelerometer and turn one of the first audio output module and the second audio output module off after determining the angle is greater than the reference angle.

6. The electronic device of claim 5, wherein the control module is further configured to switch an operating system of the electronic device from a first model to a second model after determining the rotating angle is greater than the reference angle.

7. The electronic device of claim 5, wherein the first audio output module and the second audio output module are disposed on opposite sides of the electronic device.

8. The electronic device of claim 5, wherein the X, Y axes is defined in a plane of the electronic device, and the control module is configured to obtain a tangent value according to two sensed values corresponding to the X, Y axes, and further obtain the rotating angle according to the tangential value.

9. An audio output control method, comprising:
providing an electronic device, the electronic device comprising a storing module, an accelerometer, a first audio output module, and a control module;
the accelerometer obtains acceleration of the electronic device along three axes X, Y, Z when the electronic device is rotated, wherein the three X, Y, Z axes are all perpendicular to each other; and
the control module obtains an angle of rotation according to the values, and activates the first audio output module after determining the angle is greater than the reference angle.

10. The audio output control method of claim 9, wherein the control module switches an operating system of the electronic device from a first model to a second model after determining the rotating angle is greater than the reference angle.
